(19) United States
(12) Patent Application Publication
(10) Pub. No.: US 2025/0126627 A1
(43) Pub. Date: Apr. 17, 2025

(54) METHOD, DEVICE AND COMPUTER PROGRAM PRODUCT FOR WIRELESS COMMUNICATION

(71) Applicant: ZTE Corporation, Shenzhen (CN)

(72) Inventors: Yuzhou Hu, Shenzhen (CN); Youxiong Lu, Shenzhen (CN); Weimin Xing, Shenzhen (CN); Haigang He, Shenzhen (CN)

(73) Assignee: ZTE Corporation, Shenzhen (CN)

(21) Appl. No.: 18/990,824

(22) Filed: Dec. 20, 2024

Related U.S. Application Data
(63) Continuation of application No. PCT/CN2022/106049, filed on Jul. 15, 2022.

(51) Int. Cl. H04W 72/25; H04L 5/00

(52) U.S. Cl. CPC H04W 72/25; H04L 5/0055; H04L 5/0094

(57) ABSTRACT

A method, device, and computer program product for wireless communication are provided, the method including transmitting, by a first wireless communication terminal to a second wireless communication terminal, a physical sidelink feedback channel, PSFCH, via common resource blocks, RBs, wherein the common RBs are shared by one or more PSFCHs.

### CROSS-REFERENCE TO RELATED APPLICATION

This application is a Continuation of PCT/CN2022/106049, filed on Jul. 15, 2022, titled “METHOD, DEVICE AND COMPUTER PROGRAM PRODUCT FOR WIRELESS COMMUNICATION”, and published as WO 2024/011604 A1 on Jan. 18, 2024, the entirety of which is incorporated herein by reference.

### TECHNICAL FIELD

This document is directed generally to wireless communications, in particular to 5^{th} generation (5G) or 6^{th} generation (6G) wireless communication.

### SUMMARY

To meet the OCB (occupied channel bandwidth) requirement over the unlicensed spectrum, the channel structure of PSFCH (physical sidelink feedback channel) needs to evolve. However, extending each single PSFCH from an RB to an interlace would be resource consuming in the frequency domain, particularly considering the mapping between the PSSCH (physical sidelink shared channel) and the PSFCH may be 1-to-multiple to guarantee the feedback delivery. Moreover, there exists an in-band emission (IBE) issue due to the power leakage from an RB (resource block) in an interlace to other RBs in adjacent interlaces.

The present disclosure relates to methods, devices, and computer program products for sidelink transmission including PSFCH.

One aspect of the present disclosure relates to a wireless communication method. In an embodiment, the wireless communication method includes: transmitting, by a first wireless communication terminal to a second wireless communication terminal, a physical sidelink feedback channel, PSFCH, via common resource blocks, RBs, wherein the common RBs are shared by one or more PSFCHs. It should be noted that, the term “RB” used in this disclosure may indicate interlace resource block non-interlace resource block, physical resource block, and/or virtual resource block (usually simply denoted as RB), unless expressly stated otherwise.

Another aspect of the present disclosure relates to a wireless communication method. In an embodiment, the wireless communication method includes: receiving, by a second wireless communication terminal from a first wireless communication terminal, a physical sidelink feedback channel, PSFCH, via common resource blocks, RBs, wherein the common RBs are shared by one or more PSFCHs.

Another aspect of the present disclosure relates to a wireless communication terminal. In an embodiment, the wireless communication terminal includes a communication unit and a processor. The processor is configured to: transmit, to a second wireless communication terminal, a physical sidelink feedback channel, PSFCH, via common resource blocks, RBs, wherein the common RBs are shared by one or more PSFCHs.

Another aspect of the present disclosure relates to a wireless communication terminal. In an embodiment, the wireless communication terminal includes a communication unit and a processor. The processor is configured to: receive, from a first wireless communication terminal, a physical sidelink feedback channel, PSFCH, via common resource blocks, RBs, wherein the common RBs are shared by one or more PSFCHs.

Various embodiments may preferably implement the following features:
Preferably, the common RBs are not associated with a physical sidelink shared channel, PSSCH, received by the first wireless communication terminal from the second wireless communication terminal.
Preferably, the common RBs are contiguous or non-contiguous.
Preferably, the common RBs are preconfigured, configured or predetermined per resource pool, per RB set or per subchannel.
Preferably, the common RBs comprise an intra-cell guard RB.
Preferably, the common RBs are determined according to a bitmap or at least one of: a preconfigured, or configured or predetermined number of the common RBs or IRBs, a preconfigured, configured or predetermined offset, a preconfigured, configured or predetermined offset with respect to a reference point.
Preferably, the preconfigured, configured or predetermined offset (with respect to a reference point) is a frequency offset measured in the unit of RB or IRB and can be 0.
Preferably, the reference point can be the highest or lowest RB (RB with the highest or lowest index) in a resource pool, subchannel, RB set or BWP.
Preferably, a length of the bitmap corresponds to a number of RBs in an interlace, in resource pool, in an RB set, in a subchannel, in a BWP, or in a set of RBs.
Preferably, the set of RBs is indicated as the RBs not used for carrying the PSFCH information via a bit status in the bitmap.
Preferably, a length of the bitmap corresponds to a number of interlaced resource blocks, IRBs, in a resource pool, in an RB set, in a subchannel, in a BWP, or in a set of IRBs.
Preferably, the set of IRBs is indicated as the IRBs not used for carrying the PSFCH information via a bit status in the bitmap.
Preferably, a bit of the bitmap has a first status indicating that a corresponding RB or IRB is not used for a Hybrid Automatic Repeat Request (HARQ) acknowledgement (ACK) feedback or inter user equipment coordination (IUC) information.
Preferably, a bit of the bitmap has a second status indicating that a corresponding RB or IRB is used for a HARQ ACK feedback or inter user equipment coordination (IUC) information.
Preferably, a bit of the bitmap has a third status indicating that a corresponding RB or IRB is one of the common RBs.
Preferably, a pre-configuration, configuration or pre-determination common to multiple PSFCHs carrying HARQ-ACK feedback and IUC information indicates one or more RBs, IRBs, or resource elements (REs) not used for any transmission.
Preferably, the common RBs comprise guard RBs, IRBs, or resource elements, REs, and the guard RBs, IRBs or REs comprise at least one of: highest or lowest configured, preconfigured or predetermined RBs, IRBs or REs of an RB group in the common RBs.
Preferably, the RB group is a set of RBs comprising at least one of: adjacent RBs or IRBs in the common RBs or lowest or highest RBs or IRBs in the common RBs or IRBs.
Preferably, a bit of the bitmap has a fourth status indicating a corresponding RB or IRB is not used for any transmission.
Preferably, a guard resource set of comprising at least one of: one or more RBs, one or more IRBs, or one or more REs not used for any transmission having a configured, preconfigured or predetermined offset relative to the common RBs or IRBs, or a reference point.
Preferably, the reference point can be the highest or lowest RB (RB with the highest or lowest index) in a resource pool, subchannel, RB set or BWP.
Preferably, the common RBs are determined based on base RBs, and the base RBs are determined according to a number of RBs or IRBs from a resource pool, subchannel, RB set, or BWP, and at least one of: a length of a bitmap for indicating the transmitted PSFCH carrying an HARQ-ACK, a length of a bitmap for indicating the transmitted PSFCH carrying IUC information, or a sum of the length of the bitmap for indicating the transmitted PSFCH carrying an HARQ-ACK and the length of the bitmap for indicating the transmitted PSFCH carrying the IUC information.
Preferably, the number of base RBs or IRBs is determined as a remainder of the number of RBs or IRBs from a resource pool, subchannel, RB set, or BWP divided by at least one of: a length of a bitmap for indicating the transmitted PSFCH carrying an HARQ-ACK, a length of a bitmap for indicating the transmitted PSFCH carrying IUC information, or a sum of the length of the bitmap for indicating the transmitted PSFCH carrying an HARQ-ACK and the length of the bitmap of the transmitted PSFCH carrying the IUC information.
Preferably, a number of the common RBs or IRBs are determined by equally dividing or distributing a number of the base RBs or IRBs among the resource pool, subchannel, RB set, a set of RB or BWP.
Preferably, the common RBs or IRBs are a subset of the base RBs or IRBs indicated via a common RB or IRB bitmap or at least one of: a preconfigured, configured or predetermined number of the common RBs or IRBs, a preconfigured, configured or predetermined offset, a preconfigured, configured or predetermined offset with respect to a reference point.
Preferably, the preconfigured, configured or predetermined offset (with respect to a reference point) can be a frequency offset measured in the unit of RB or IRB and can be 0.
Preferably, the reference point can be the highest or lowest RB (RB with the highest or lowest index) in a resource pool, subchannel, RB set or BWP.
Preferably, the base RBs or IRBs include guard RBs or IRBs
Preferably, the guard RBs are a subset of the base RBs indicated via a RB or IRB bitmap or at least one of: a preconfigured, configured or predetermined number of the guard RBs or IRBs, a pre-configured, configured or predetermined offset, a pre-configured, configured or predetermined offset with respect to a reference point.
Preferably, the pre-configured, configured or predetermined offset (with respect to a reference point) is a frequency offset measured in the unit of RB or IRB and can be 0.
Preferably, the reference point can be the highest or lowest RB or IRB (RB or IRB with the highest or lowest index) in a resource pool, subchannel, RB set or BWP.
Preferably, a guard interlace set comprising one or more configured, pre-configured or predetermined interlace not used for any transmission having a configured, preconfigured, or predetermined offset relative to the common RBs or IRBs, or a reference point.
Preferably, the reference point can be the highest or lowest RB (RB with the highest or lowest index) in a resource pool, subchannel, RB set or BWP.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a diagram of resource blocks according to an embodiment of the present disclosure.

FIG. 2 shows a diagram of resource blocks according to another embodiment of the present disclosure.

FIG. 3 shows a diagram of resource blocks according to another embodiment of the present disclosure.

FIG. 4 shows a diagram of resource blocks according to another embodiment of the present disclosure.

FIG. 5 shows a diagram of resource blocks according to another embodiment of the present disclosure.

FIG. 6 shows a schematic diagram of a wireless communication terminal according to an embodiment of the present disclosure.

### DETAILED DESCRIPTION

In some embodiments, for interlaced transmission, the number of CRBs contained in an interlace may be more than 10.

In some embodiments, for PSFCH and PSSCH (physical sidelink shared channel) association, the start-subchannel association or all-subchannel association may be used. The all-subchannel association may be more demanding if each interlace of PSFCH is associated with a PSFCH.

In some embodiments, a UE (user equipment) may determine a number of PSFCH resources available for multiplexing the HARQ-ACK (Hybrid Automatic Repeat Request Acknowledgement) or the conflict information in a PSFCH transmission.

### Embodiment 1

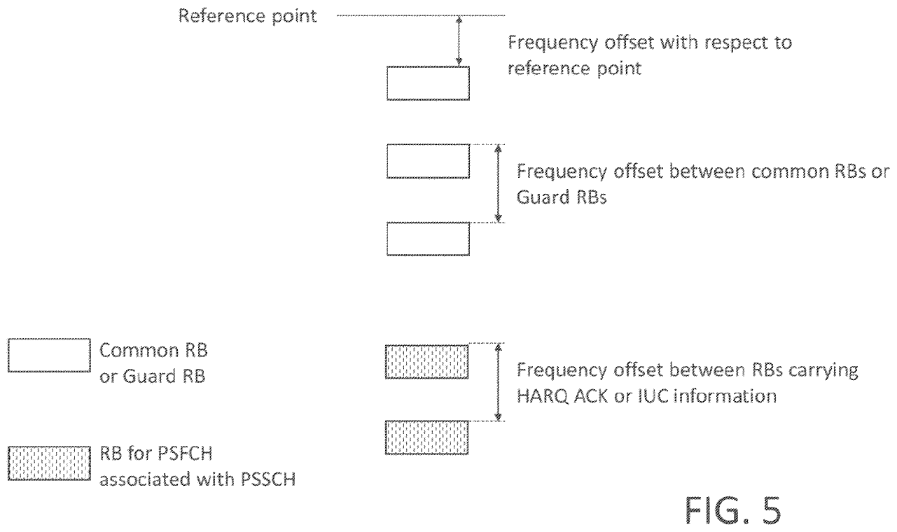

In an embodiment, a set of RBs or IRBs are (pre-)configured or predetermined as common RBs or IRBs. In an embodiment, each PSFCH may occupy some or all the resources on these RBs or IRBs. In an embodiment, these RBs or IRBs are shared by one or more PSFCHs. These RBs or IRBs are denoted as common RBs or IRBs hereafter. In an embodiment, the one or more PSFCHs may carry HARQ-ACK feedback and IUC information. In an embodiment, the common RB or IRB can be either contiguous or non-contiguous. In an embodiment, the common RBs or IRBs can be (pre-)configured or predetermined per resource pool, per RB set or per subchannel. In an embodiment, the common RBs or IRBs may contain intra-cell guard RBs or IRBs. In an embodiment, as illustrated in FIG. 5, the common RBs or IRBs can be (pre-)configured or determined via a bitmap or via at least one of a (pre-)configured and/or predetermined number of RBs, a (pre-)configured and/or predetermined offset measured in RB or IRB, a (pre-)configured and/or predetermined offset measured in RB or IRB with respect to a reference point. The reference point can be the highest or lowest RB and/or IRB (e.g., the RB and/or IRB with the highest or lowest index) in a resource pool, subchannel, RB set or BWP. In an embodiment, the length of the bitmap can be associated with (e.g., equal to) the number of RBs in an interlace, a resource pool, an RB set, a subchannel, a BWP (bandwidth part), or a set of RBs (e.g., this set of RBs indicated as not used for carrying the PSFCH information via a bit status in a bitmap). In an embodiment, the length of the bitmap can be associated with (e.g., equal to) a number of an IRB (interlace resource block) in a resource pool, an RB set, a subchannel, a BWP or a set of IRBs (e.g., this set of IRBs are indicated as not used for carrying the PSFCH information via a bit status in a bitmap).

It should be noted that, the term “RB” used in this disclosure may indicate interlace resource block, non-interlace resource block, physical resource block, and/or virtual resource block, unless expressly stated otherwise.

### Embodiment 2

In an embodiment, the common RBs or IRBs can be indicated via a bitmap L. In an embodiment, the length of the bitmap L may be associated with (e.g., equal to) the number of RBs or IRBs within the resource pool. In an embodiment, each bit of the bitmap L includes three statuses, which are denoted as, for example, Status 0, Status 1, and Status 2. A bit with status 0 indicates a corresponding RB or IRB that is not used for HARQ ACK feedback or inter-UE coordination information. A bit with status 1 indicates a corresponding RB or IRB for the PSFCH that is used for HARQ ACK feedback or inter-UE coordination information. A bit with status 2 indicates a corresponding RB or IRB is one of the common RBs that are shared by one or more PSFCHs and are not associated with PSSCH. In an embodiment, a PSFCH carrying a HARQ-ACK feedback and inter-UE coordination information may correspond to a dedicated bitmap L respectively.

### Embodiment 3

In an embodiment, the common RBs or IRBs can be indicated via a bitmap L. In an embodiment, each bit of the bitmap L includes three statuses, which are denoted as, for example, Status 0, Status 1, and Status 2. A bit with status 0 indicates a corresponding RB or IRB that is not used for HARQ ACK feedback or inter-UE coordination information. A bit with status 1 indicates a corresponding RB or IRB for the PSFCH that is used for HARQ ACK feedback or inter-UE coordination information. A bit with status 2 indicates a corresponding RB or IRB is one of the common RBs that are shared by multiple PSFCHs and are not associated with PSSCH. In an embodiment, a PSFCH carrying a HARQ-ACK feedback and inter-UE coordination information may correspond to a dedicated bitmap L respectively. In an embodiment, a pre-configuration, configuration or predetermination common to multiple PSFCHs carrying HARQ-ACK feedback and IUC information indicates one or more RBs (e.g., guard RBs) not used for any transmission. The pre-configuration, configuration, predetermination may be done via a bitmap having at least one status, e.g. 0 indicating one or more RBs are not used for any transmission. In an embodiment, as illustrated in FIG. 5, the pre-configuration, configuration or predetermination can be done via at least one of: a preconfigured or configured number of the common RBs or IRBs, a preconfigured or configured offset, a preconfigured or configured offset with respect to a reference point.

### Embodiment 4

In an embodiment, the common RBs or IRBs can be indicated via a bitmap L. In an embodiment, each bit of the bitmap L includes three statuses, which are denoted as, for example, Status 0, Status 1, and Status 2. A bit with status 0 indicates a corresponding RB or IRB that is not used for HARQ ACK feedback or inter-UE coordination information. A bit with status 1 indicates a corresponding RB or IRB for the PSFCH that is used for HARQ ACK feedback or inter-UE coordination information. A bit with status 2 indicates a corresponding RB or IRB is one of the common RBs that are shared by multiple PSFCHs and are not associated with PSSCH. In an embodiment, a PSFCH carrying a HARQ-ACK feedback and inter-UE coordination information may correspond to a dedicated bitmap L respectively. In an embodiment, the common RBs or IRBs may have guard RBs, IRBs or resource elements, REs, and the guard RBs, IRBs or REs may have at least one of: highest or lowest configured, preconfigured or predetermined RBs, IRBs or REs of an RB group (e.g., including one or more of the common RBs or IRBs) in the common RBs or IRBs. In an embodiment, the RB group is a set of RBs comprising at least one of: adjacent RBs or IRBs in the common RBs or IRBs, the lowest RBs or IRBs (the RBs or IRBs with the lowest index) in the common RBs or IRBs, or the highest RBs or IRBs (the RBs or IRBs with the highest index) in the common RBs or IRBs.

### Embodiment 5

In an embodiment, the common RBs or IRBs can be indicated via a bitmap L. In an embodiment, each bit of the bitmap L includes four statuses, which are denoted as, for example, Status 0, Status 1, Status 2, and Status 3. A bit with status 0 indicates a corresponding RB or IRB that is not used for HARQ ACK feedback or inter-UE coordination information. A bit with status 1 indicates a corresponding RB or IRB for the PSFCH that is used for HARQ ACK feedback or inter-UE coordination information. A bit with status 2 indicates a corresponding RB or IRB is one of the common RBs that are shared by multiple PSFCHs and are not associated with PSSCH. A bit with status 3 indicates a corresponding RB or IRB is a guard RB or IRB where any signal/channel, including e.g., the HARQ ACK feedback, the inter-UE coordination information, or the S-SSB (sidelink synchronization signal block), cannot be transmitted. In an embodiment, a PSFCH carrying a HARQ-ACK feedback and inter-UE coordination information may correspond to a dedicated bitmap L respectively.

### Embodiment 6

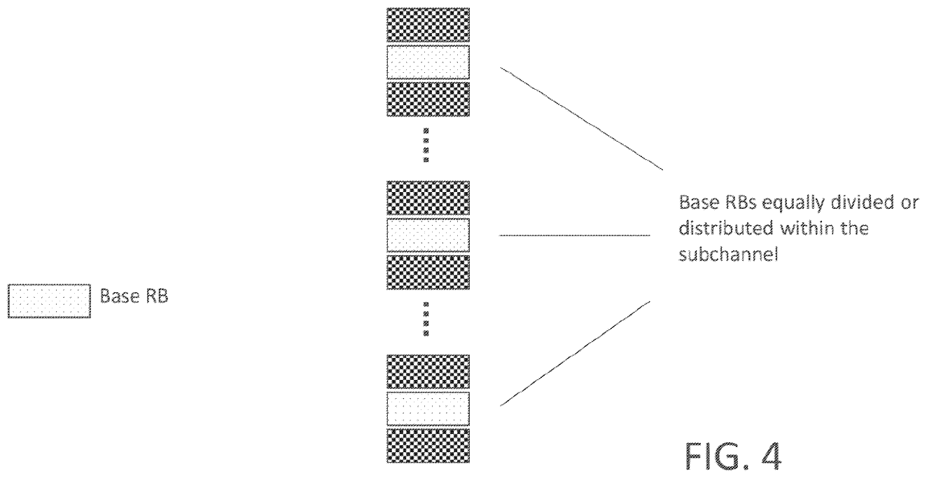

In an embodiment, the common RBs are determined based on base RBs, and the base RBs are determined according to number A and number B. In an embodiment, number A is a number of RBs or IRBs from a resource pool, subchannel, RB set, or BWP, and number B is at least one of: a length of a bitmap for indicating the transmitted PSFCH carrying an HARQ-ACK, a length of a bitmap for indicating the transmitted PSFCH carrying IUC information, or a sum of the length of the bitmap for indicating the transmitted PSFCH carrying an HARQ-ACK and the length of the bitmap for indicating the transmitted PSFCH carrying the IUC information. In an embodiment, the base RBs is a remainder of number A divided by number B. For example, assuming the number of RBs or IRBs from a resource pool, subchannel, RB set, or BWP is 25 and the sum of the length of the bitmap for indicating the transmitted PSFCH carrying an HARQ-ACK and the length of the bitmap for indicating the transmitted PSFCH carrying the IUC information is 20, the number of the base RBs is 5. In an embodiment, the base RBs can be distributed at the edge and/or center of the resource pool, the RB set, the subchannel or the BWP. In an embodiment, as illustrated in FIG. 4, a number of the common RBs are determined by equally dividing or distributing a number of the base RBs among the resource pool, the RB set, the subchannel, a set of RB or the BWP. The set of RB herein refers to a preconfigured, configured or predetermined number of RBs from a resource pool, subchannel, RB set, or BWP.

In an embodiment, the common RBs or IRBs are a subset of the base RBs or IRBs indicated via a common RB or IRB bitmap or at least one of: a preconfigured, configured or predetermined number of the common RBs or IRBs, a preconfigured, configured or predetermined offset, a preconfigured, configured or predetermined offset with respect to a reference point (see FIG. 5). The preconfigured, configured or predetermined offset (with respect to a reference point) can be a frequency offset measured in the unit of RB or IRB and can be 0 (see FIG. 5). The reference point can be the highest or lowest PRB or IRB (PRB or IRB with the highest or lowest index) in a resource pool, subchannel, RB set or BWP. In an embodiment, the length of the common RB or IRB bitmap is associated with (e.g., equal to or being a fraction of) a number of the base RBs or IRBs.

In an embodiment, the guard RBs or IRBs are a subset of the base RBs or IRBs indicated via a guard RB or IRB bitmap or at least one of: a preconfigured, configured or predetermined number of the guard RBs or IRBs, a preconfigured, configured or predetermined offset, a pre-configured, configured or predetermined offset with respect to a reference point (see FIG. 5). The pre-configured, configured or predetermined offset (with respect to a reference point) can be a frequency offset measured in the unit of RB or IRB and can be 0 (see FIG. 5). The reference point can be the highest or lowest PRB or IRB (PRB or IRB with the highest or lowest index) in a resource pool, subchannel, RB set or BWP. In an embodiment, the length of the guard RB or IRB bitmap is associated with (e.g. equal to or being a fraction of) a number of the base RBs or IRBs.

### Embodiment 7

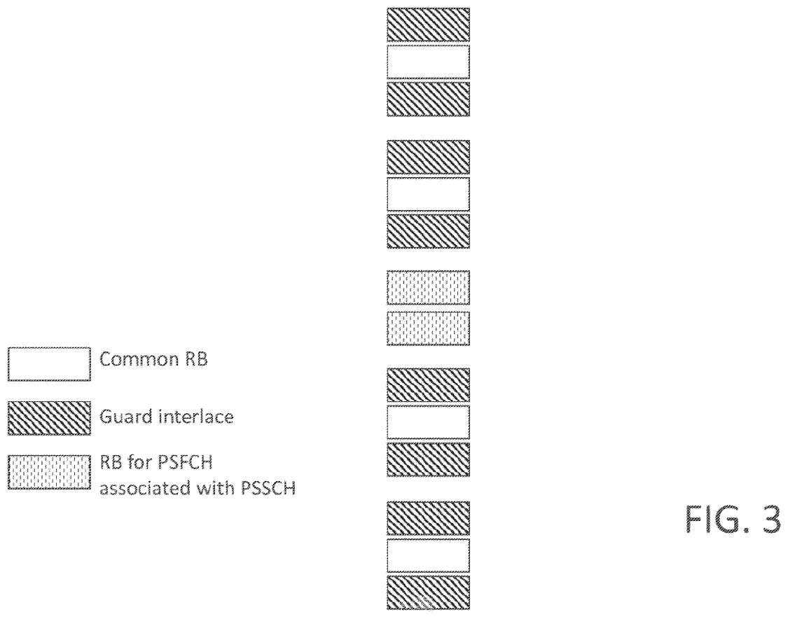

In an embodiment, as shown in FIG. 3, a guard interlace set comprising at least one of a configured, pre-configured or predetermined guard interlace not used for any transmission has a configured, preconfigured, or predetermined offset relative to the common RBs or IRBs.

### Embodiment 8

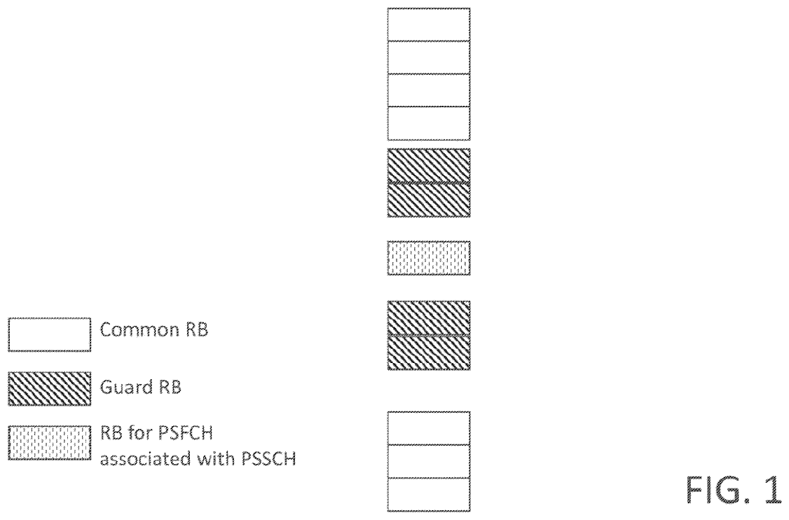

FIG. 1 shows a diagram of resource blocks according to an embodiment of the present disclosure. As illustrated in FIG. 1, the common RBs able to be shared by one or more PSFCHs are configured. The common RBs are not associated with the PSSCH (e.g., not used to carrying the HARQ-ACK feedback and the inter-UE coordination information). Besides, the guard RBs which are not used for any transmission are configured.

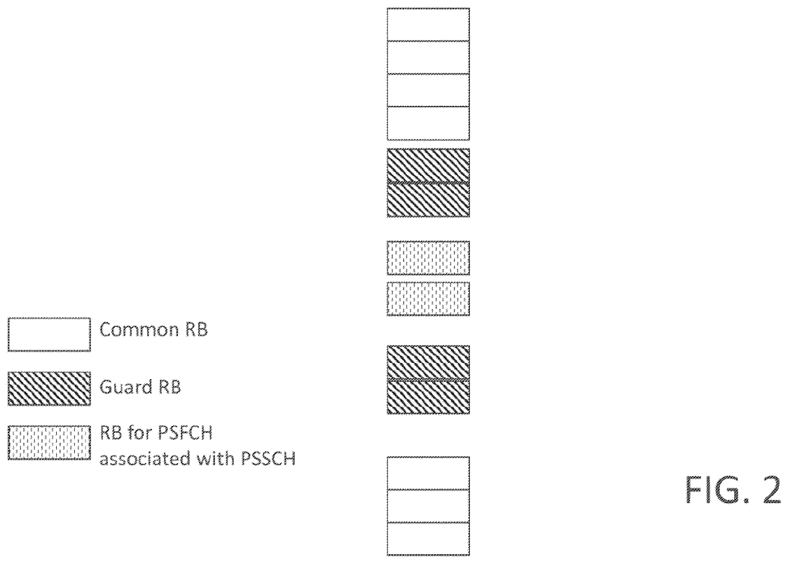

FIG. 2 shows a diagram of resource blocks according to an embodiment of the present disclosure. As illustrated in FIG. 2, a (pre-) configured offset may exist between multiple RBs associated with a single PSFCH.

FIG. 3 shows a diagram of resource blocks according to an embodiment of the present disclosure. As illustrated in FIG. 3, the guard interlace set including one or more guard interlaces can be configured. One guard interlace, for example, may include one or more guard RBs and/or interlace with a frequency offset (e.g. 0) to the common RBs.

### Embodiment 9

In an embodiment, Dedicated common RBs can be configured, pre-configured or predetermined for a PSFCH carrying ACK (acknowledgement) or NACK (negative acknowledgement) feedback respectively. The common RBs for the ACK or NACK feedback can be configured or preconfigured via separate bit status in a bitmap or configured, pre-configured or predetermined separately via at least one of: a preconfigured, configured, or predetermined number of the common RBs or IRBs, a preconfigured, configured or predetermined offset or a preconfigured, configured or predetermined offset with respect to a reference point.

Depending on whether to transmit a PSFCH carrying ACK or NACK feedback, the UE may perform the transmission via the common RBs corresponding to either the ACK or NACK feedback.

In an embodiment, as shown in FIG. 2 or FIG. 3, the pattern of the PSFCH resources carrying HARQ-ACK information or IUC information may be indicated via at least one of the following: a configured number of RBs, a (pre-)configured or pre-determined offset and/or a (pre-)configured or pre-determined offset with respect to a reference point.

In an embodiment, as shown in FIG. 4, the base RBs or IRBs may be equally divided or distributed within the subchannel comprising the common RBs or IRBs.

In an embodiment, as shown in FIG. 5, the RBs or IRBs carrying HARQ ACK information or IUC information in PSFCH have a configured, pre-configured or predetermined frequency offset. The common RBs or IRBs or guard RBs or IRBs have a configured, pre-configured or predetermined frequency offset therebetween. The common RBs or IRBs or guard RBs or IRBs have a configured, pre-configured or predetermined frequency offset relative to the reference point.

In an embodiment, a guard resource set of comprising at least one of an RB, an IRB, or an RE not used for any transmission has a configured, pre-configured or pre-determined offset relative to the common RBs.

In accordance with an embodiment of the present disclosure, a wireless communication method includes transmitting, by a first wireless communication terminal (e.g., a UE) to a second wireless communication terminal (e.g., another UE), a physical sidelink feedback channel, PSFCH, via common resource blocks, RBs, wherein the common RBs are shared by one or more (other) PSFCHs.

In accordance with an embodiment of the present disclosure, a wireless communication method includes receiving, by a second wireless communication terminal from a first wireless communication terminal, a physical sidelink feedback channel, PSFCH, via common resource blocks, RBs, wherein the common RBs are shared by one or more (other) PSFCHs.

Details of the common RBs, PSFCHs, and relevant configurations or operations can be ascertained by referring to the paragraphs above, and will not be repeated herein.

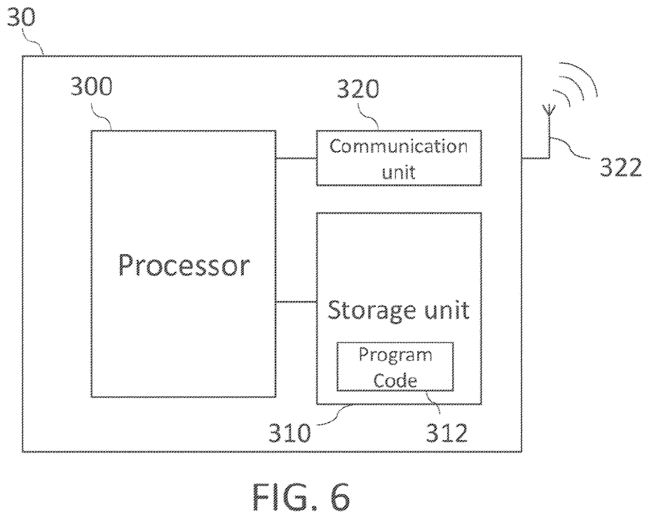

FIG. 6 relates to a diagram of a wireless communication terminal 30 according to an embodiment of the present disclosure. The wireless communication terminal 30 may be a tag, a mobile phone, a laptop, a tablet computer, an electronic book or a portable computer system and is not limited herein. The wireless communication terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322.

In an embodiment, the storage unit 310 and the program code 312 may be omitted and the processor 300 may include a storage unit with stored program code.

The processor 300 may implement any one of the steps in exemplified embodiments on the wireless communication terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless communication node.

In some embodiments, the wireless communication terminal 30 may be used to perform the operations of one of the tags described above. In some embodiments, the processor 300 and the communication unit 320 collaboratively perform the operations described above. For example, the processor 300 performs operations and transmit or receive signals, message, and/or information through the communication unit 320.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method comprising:
transmitting, by a first wireless communication terminal to a second wireless communication terminal, a physical sidelink feedback channel, PSFCH, via common resource blocks, RBs, wherein the common RBs are shared by one or more PSFCHs.

2. The wireless communication method of claim 1, wherein the common RBs are not associated with a physical sidelink shared channel, PSSCH, received by the first wireless communication terminal from the second wireless communication terminal.

3. The wireless communication method of claim 1, wherein the common RBs are contiguous or non-contiguous.

4. The wireless communication method of claim 1, wherein the common RBs are preconfigured, configured or predetermined per resource pool, per RB set or per subchannel.

5. The wireless communication method of claim 1, wherein the common RBs comprise one or more intra-cell guard RB.

6. The wireless communication method of claim 1, wherein the common RBs are determined according to a bitmap or at least one of: a preconfigured, configured or predetermined number of the common RBs or IRBs, a preconfigured, configured or predetermined offset, a preconfigured, configured or predetermined offset with respect to a reference point.

7. The wireless communication method of claim 6, wherein a length of the bitmap corresponds to a number of RBs in an interlace, in resource pool, in an RB set, in a subchannel, in a bandwidth part, BWP, or in a set of RBs.

8. The wireless communication method of claim 7, wherein the set of RBs is indicated as the RBs not used for carrying the PSFCH information via a bit status in the bitmap.

9. The wireless communication method of claim 6, wherein a length of the bitmap corresponds to a number of interlaced resource blocks, IRBs, in a resource pool, in an RB set, in a subchannel, in a BWP, or in a set of IRBs.

10. The wireless communication method of claim 9, wherein the set of IRBs is indicated as the IRBs not used for carrying the PSFCH information via a bit status in the bitmap.

11. The wireless communication method of claim 6, wherein a bit of the bitmap has a first status indicating that a corresponding RB or IRB is not used for a Hybrid Automatic Repeat Request (HARQ) acknowledgement (ACK) feedback or inter user equipment coordination (IUC) information.

12. The wireless communication method of claim 6, wherein a bit of the bitmap has a second status indicating that a corresponding RB or IRB is used for a HARQ ACK feedback or inter user equipment coordination (IUC) information.

13. The wireless communication method of claim 6, wherein a bit of the bitmap has a third status indicating that a corresponding RB or IRB is one of the common RBs.

14. The wireless communication method of claim 6, wherein a pre-configuration, configuration or predetermination common to multiple PSFCHs carrying HARQ-ACK feedback and IUC information indicates one or more RBs, IRBs or REs not used for any transmission.

15. The wireless communication method of claim 6, wherein the common RBs comprise guard RBs, IRBs or resource elements, REs, and the guard RBs, IRBs or REs comprise at least one of: highest or lowest configured, preconfigured or predetermined RBs, IRBs or REs of an RB group in the common RBs.

16. The wireless communication method of claim 15, wherein the RB group is a set of RBs comprising at least one of: adjacent RBs or IRBs in the common RBs or lowest or highest RBs or IRBs in the common RBs or IRBs.

17. The wireless communication method of claim 6, wherein a bit of the bitmap has a fourth status indicating a corresponding RB or IRB is not used for any transmission.

18. The wireless communication method of claim 1, wherein a guard resource set of comprising at least one of: one or more RBs, one or more IRBs, or one or more REs not used for any transmission having a configured, preconfigured or predetermined offset relative to the common RBs or IRBs.

19. The wireless communication method of claim 1, wherein the common RBs are determined based on base RBs, and the base RBs are determined according to a number of RBs or IRBs from a resource pool, subchannel, RB set, or BWP, and at least one of: a length of a bitmap for indicating the transmitted PSFCH carrying an HARQ-ACK, a length of a bitmap for indicating the transmitted PSFCH carrying IUC information, or a sum of the length of the bitmap for indicating the transmitted PSFCH carrying an HARQ-ACK and the length of the bitmap for indicating the transmitted PSFCH carrying the IUC information.

20. The wireless communication method of claim 19, wherein the number of base RBs is determined as a remainder of the number of RBs or IRBs from a resource pool, subchannel, RB set, or BWP divided by at least one of: a length of a bitmap for indicating the transmitted PSFCH carrying an HARQ-ACK, a length of a bitmap for indicating the transmitted PSFCH carrying IUC information, or a sum of the length of the bitmap for indicating the transmitted PSFCH carrying an HARQ-ACK and the length of the bitmap for indicating the transmitted PSFCH carrying the IUC information.
